(19) United States
(12) Patent Application Publication
(10) Pub. No.: US 2023/0249950 A1
(43) Pub. Date: Aug. 10, 2023

(54) CRANE FALL PROTECTION SYSTEM

(71) Applicant: Marmon Crane Services, Inc., Chicago, IL (US)

(72) Inventors: Timothy J. BENJAMIN, Sharpsburg, GA (US); Brian Andrew BOUDREAUX, Spring, TX (US); Roland VON KURNATOWSKI, Houston, TX (US); Zach SCHULTZ, Houston, TX (US); Meredith TUCKER, Houston, TX (US)

(73) Assignee: Marmon Crane Services, Inc., Chicago, IL (US)

(21) Appl. No.: 18/146,857

(22) Filed: Dec. 27, 2022

Related U.S. Application Data
(60) Provisional application No. 63/294,101, filed on Dec. 28, 2021.

(51) Int. Cl. B66C 23/88

(52) U.S. Cl. CPC B66C 23/88; B66C 23/78

(57) ABSTRACT

A crane fall protection system is disclosed herein for use within building or construction sites. The system may comprise a safety net and an adjustable scaffold structural member. The adjustable scaffold structural member may be provided as a deployable arm that extends from the side of a crane. In some embodiments, the system may include an access flap that enables an operator to access a ladder of the crane without removing the safety net. In some embodiments, one or more tension wires may extend from the safety net and/or the scaffold structural member and attach to a pad positioned underneath an outrigger of the vehicle to provide additional support for the safety net. In some embodiments, air inflatable units may be used instead of a safety net. In some embodiments, connections to outriggers may be used to suspend the safety net instead of a scaffold structural member.

### RELATED APPLICATIONS

This application claims priority to U.S. Provisional Patent Application No. 63/294,101, filed Dec. 28, 2021, the content of which is incorporated herein by reference in its entirety.

### FIELD OF THE INVENTION

The present invention relates to crane operations and, more particularly, to a safety system configured to prevent against death or serious injury when operators fall from a crane.

### BACKGROUND OF THE DISCLOSURE

Within building or construction sites, safety policies may require a scaffold or fall arrest system be set up in order for work to be performed. However, safety requirements also prohibit securing safety equipment to equipment that rotates. Accordingly, setting up and taking down adequate fall safety protection around rotating cranes can be both difficult and time-consuming. As such, there is a need for better fall protection systems for use with cranes within building or construction sites.

### SUMMARY OF THE INVENTION

Aspects of this disclosure relate to various embodiments of an improved crane fall protection system for use within building or construction sites. In various embodiments, the system comprises at least a safety net and an adjustable scaffold structural member. In some embodiments, the adjustable scaffold structural member may be provided as a deployable arm that extends from the side of a crane. In some embodiments, the crane fall protection system may include an access flap that enables an operator to access a ladder of the crane without removing the safety net. In various embodiments, structural units of the scaffold structural member may be spaced apart from one another to provide adequate structural support for the safety net. In some embodiments, one or more tension wires may extend from the safety net and/or the scaffold structural member and attach to a pad positioned underneath an outrigger of the vehicle to provide additional support for the safety net. In some embodiments, air inflatable units may be used instead of (or in addition to) a safety net. In some embodiments, connections to outriggers may be used to suspend the safety net instead of (or in addition to) a scaffold structural member.

These and other objects, features, and characteristics of the invention disclosed herein will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

The present invention is illustrated by way of example and not limited in the accompanying figures in which like reference numerals indicate similar elements and in which:

FIG. 1 depicts a perspective view of an example crane fall protection system, according to one or more aspects described herein;

FIG. 2A and FIG. 2B depict perspective views of an example scaffold structural member of a crane fall protection system, according to one or more aspects described herein;

FIG. 3A and FIG. 3B depict perspective views of an example mounting system for connecting a fall protection member of a crane fall protection system to a vehicle, according to one or more aspects described herein;

FIG. 4 depicts a perspective view of an example deployable arm-based crane fall protection system, according to one or more aspects described herein;

FIG. 5 depicts a perspective view of an example air bag-based crane fall protection system, according to one or more aspects described herein;

FIG. 6 depicts a perspective view of an example outrigger-mounted crane fall protection system, according to one or more aspects described herein.

These drawings are provided for purposes of illustration only and merely depict typical or example embodiments. These drawings are provided to facilitate the reader's understanding and shall not be considered limiting of the breadth, scope, or applicability of the disclosure. For clarity and ease of illustration, these drawings are not necessarily drawn to scale.

### DETAILED DESCRIPTION OF THE INVENTION

In the following description of various examples of the invention, reference is made to the accompanying drawings, which form a part hereof, and in which are shown by way of illustration various example structures, systems, and steps in which aspects of the invention may be practiced. It is to be understood that other specific arrangements of parts, structures, example devices, systems, and steps may be utilized, and structural and functional modifications may be made without departing from the scope of the present invention. Also, while the terms “top,” “bottom,” “front,” “back,” “side,” and the like may be used in this specification to describe various example features and elements of the invention, these terms are used herein as a matter of convenience, e.g., based on the example orientations shown in the figures. Nothing in this specification should be construed as requiring a specific three-dimensional orientation of structures in order to fall within the scope of this invention.

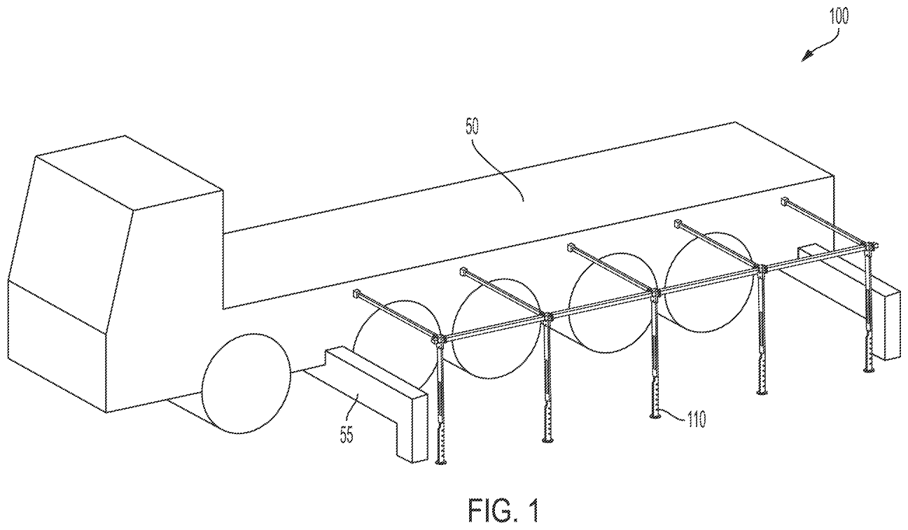

FIG. 1 depicts a perspective view of an example crane fall protection system 100, according to one or more aspects described herein. In various embodiments, crane fall protection system 100 may include one or more scaffold structural members 110 securely attached to vehicle 50. In various embodiments, vehicle 50 may comprise a crane and/or other similar type of machine. In various embodiments, vehicle 50 may include one or more outriggers 55. As described herein, scaffold structural member 110 may be selectively attached to a side of the vehicle 50 to allow good distribution of the loads and minimize shear and tensile stress caused by a falling object (e.g., construction materials, debris, an individual, and/or other types of objects) within a building or construction site.

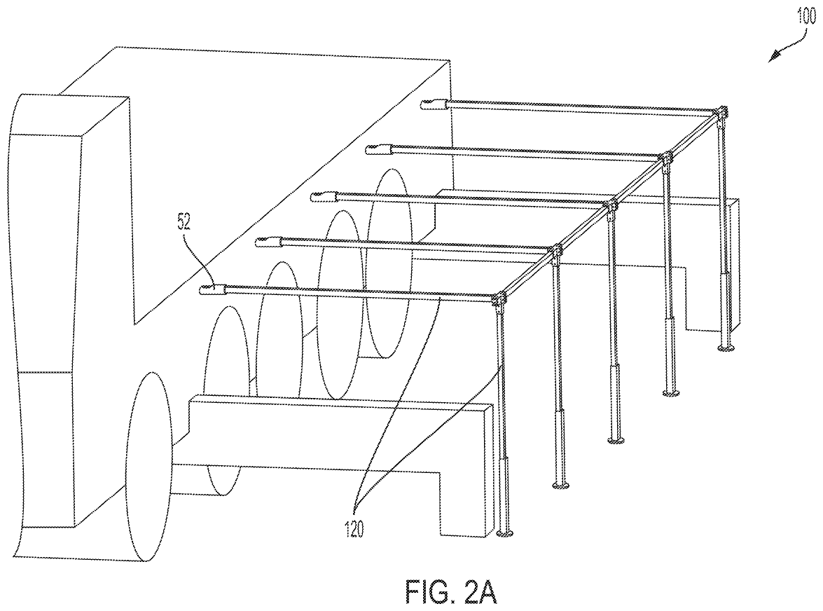

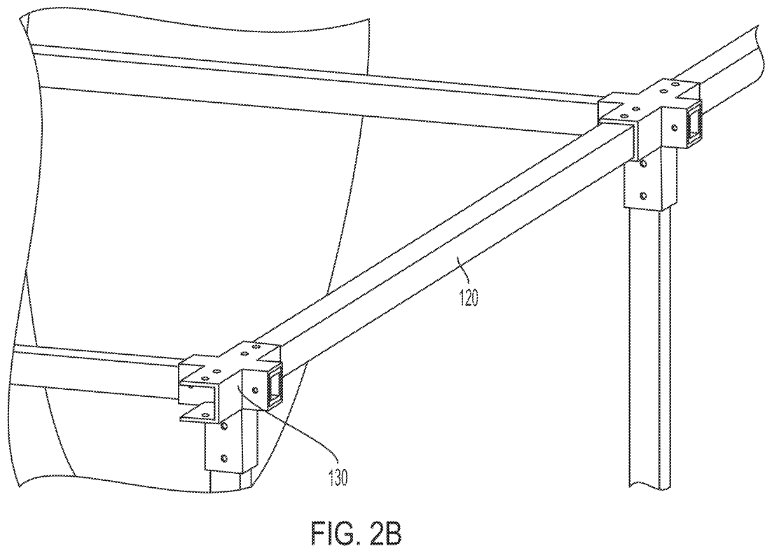

FIG. 2A depicts a perspective view of scaffold structural member 110 of crane fall protection system 100, according to one or more aspects described herein. In various embodiments, scaffold structural member 110 may be docked (or attached) to one or more mounting points 52 (also interchangeably referred to herein as connecting points 52) on vehicle 50. In various embodiments, scaffold structural member 110 may comprise one or more sets of structural units 120. In some embodiments, each structural unit 120 may comprise a square tube. For example, the structural units 120 may each comprise 2-inch×2-inch×0.25-inch square tubes. In other embodiments, each structural unit 120 may comprise tubes that are circular, non-circular, rectangular, polygonal, triangular, oval, or any other shape that facilitates construction of scaffold structural member 110. In some embodiments, the structural units 120 may be tubes having any appropriate shape and size that satisfies requirements set by the Occupational Safety and Health Administration (OSHA). For example, the structural units 120 may be tubes having any appropriate shape and size that satisfies applicable lateral stability requirements set by OSHA. In some embodiments, the one or more sets of structural units 120 and/or individual structural units 120 themselves may be detachable to enable scaffold structural member 110 to be quickly disassembled. In some embodiments, scaffold structural member 110 and/or the structural units 120 of scaffold structural member 110 may be foldable to enable scaffold structural member 110 to be conveniently stored and transported. In some embodiments, scaffold structural member 110 may be folded without having to completely detach the some or all of the structural units 120 that make up scaffold structural member 110. In some embodiments, the structural units 120 may enable a user to selectively adjust a height of scaffold structural member 110. For example, the structural units may be configured to expand or contract to increase or decrease the height of scaffold structural member 110.

FIG. 2B depicts another perspective view of scaffold structural member 110 of crane fall protection system 100, according to one or more aspects described herein. As depicted in FIG. 2B, in various embodiments, scaffold structural member 110 may be formed by connecting one or more sets of structural units 120. In various embodiments, the set of structural units 120 of scaffold structural member 110 may combine to form a scaffold structure at the base of vehicle 50 configured to support a safety net. For example, scaffold structural member 110 may include multiple sets of structural units 120 that each include a vertical structural unit 120 and two horizontal structural units 120—one mounted or connected to vehicle 50 and another that connects the set of structural units 120 to another set of structural units 120. In the foregoing example, scaffold structural member 110 may include at least one set of structural units 120 toward an end of vehicle 50 (i.e., the last set of structural units 120) that only includes a vertical structural unit 120 and a horizontal structural unit 120 mounted or connected to vehicle 50. In various embodiments, the structural units 120 that make up scaffold structural member 110 may be connected by a structural connector 130 configured to receive an end of multiple structural units. For example, in some embodiments, structural connector 130 may be configured to receive an end of up to five (5) structural units 120. In various embodiments, structural connector 130 may be configured to connect a set of structural units 120 together and to another set of structural units 120. In various embodiments, structural connector 130 may comprise any suitable connector configured to affix the structural units 120 to each other and form scaffold structural member 110. For example, structural connector 130 may comprise any form of connector configured to affix multiple structural units 120 together, including, but not limited to, a fastener, a bolt configuration, rivets, or the like. In an example embodiment, structural connectors 130 used to assemble scaffold structural member 110 may be configured to attach structural units 120 using a pin-locking component.

As described herein, scaffold structural member 110 of crane fall protection system 100 may be configured to receive and support a safety net (or safety netting). For example, in various embodiments, a safety net may be stretched across horizontal structural units 120 of scaffold structural member 110. In various embodiments, the horizontal structural units 120 of scaffold structural member 110 may be spaced apart from one another to provide appropriate structural support for a safety net stretched across the one or more sets of structural units 120. For example, the horizontal structural units 120 of scaffold structural member 110 may be spaced apart from one another to ensure good distribution of the load of the safety net while minimizing shear and tensile stress caused by a falling object within a building and construction site and within a proximity of vehicle 50.

In various embodiments, the safety net (e.g., safety net 310) may be configured to decrease impact force on falling objects while maintaining the same (or similar) impulse. In other words, the safety net may be configured to minimize damage or harm to falling objects at or around the base of a crane (or vehicle 50). In some embodiments, the safety net may comprise or include one or more components of a 3M™ DBI-SALA® netting system. In some embodiments, the safety net may be connected to scaffold structural member 110 and/or vehicle 50 at predefined maximum length intervals. For example, in some embodiments, the safety net may be connected to scaffold structural member 110 and/or vehicle 50 at a maximum of 4-foot intervals. In some embodiments, the safety net may be connected to scaffold structural member 110 and/or vehicle 50 via 3M™ DBI-SALA®-rated net hook connectors. In various embodiments, the safety net may comprise any suitable safety that is made of appropriate material and an appropriate size and that satisfies requirements set by OSHA.

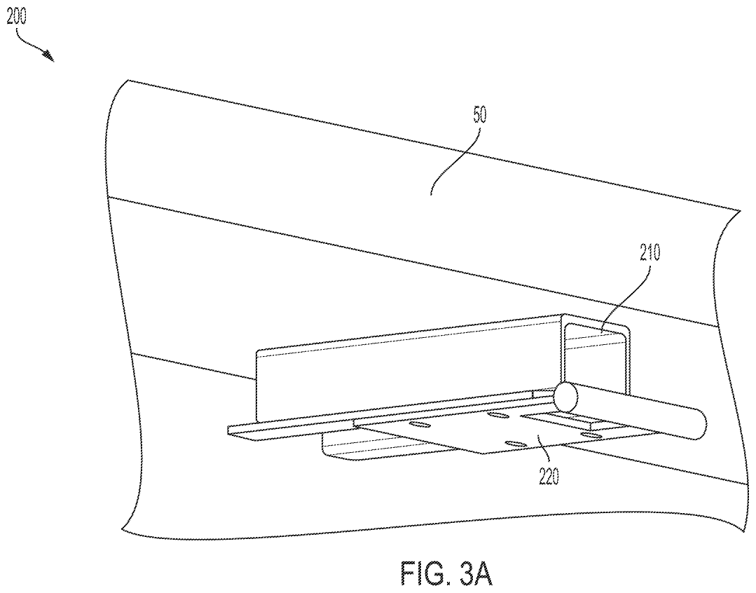

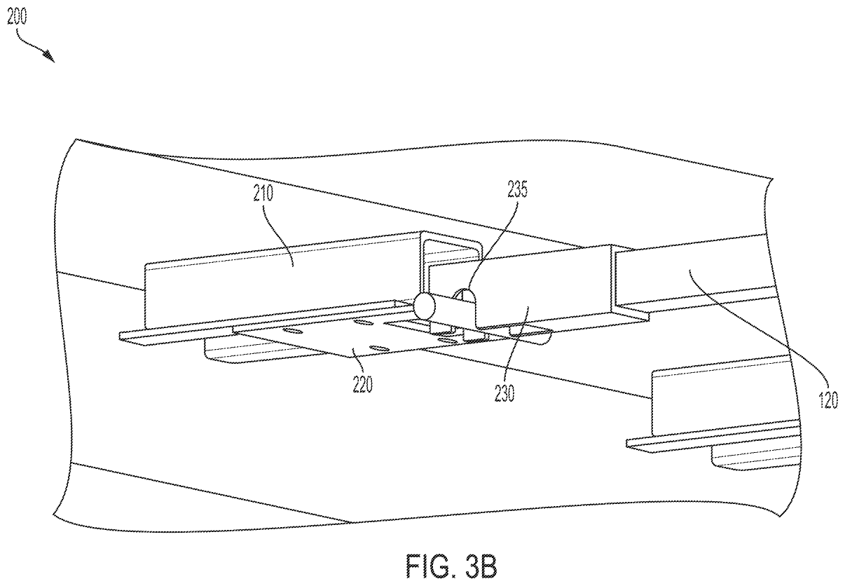

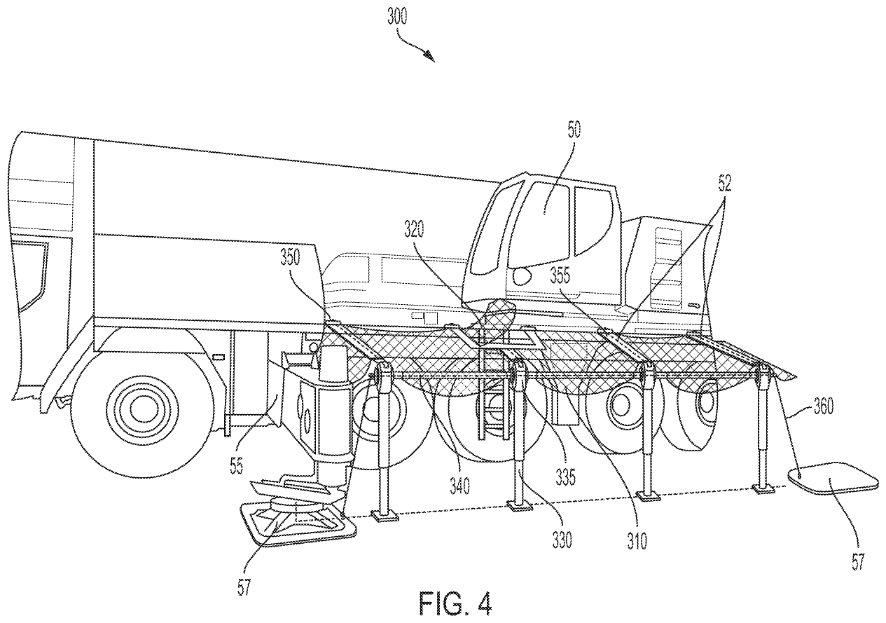

In various embodiments, the structural units 120 of scaffold structural member 110 may be mounted or connected to vehicle 50 via a mounting system 200. For example, FIG. 3A and FIG. 3B depict perspective views of a mounting system 200 via which a fall protection member of crane fall protection system 100 may be attached to vehicle 50, according to one or more aspects described herein. For example, the fall protection member of crane fall protection system 100 (e.g., the deployable arm of crane fall protection system 300) may comprise scaffold structural member 110 or a similar structural member. As described herein with respect to FIG. 4, crane fall protection system 100 may include a deployable-arm-based fall protection member comprising scaffold structural member 110 or a similar structural member.

As depicted in FIG. 3A and FIG. 3B, mounting system 200 may comprise a mounting bracket 210, an interconnect member 220, and an engaging member 230. In various embodiments, mounting system 200 may be configured to securely mount a fall protection member and/or one or more other components of crane fall protection system 100 to a side of vehicle 50. For example, mounting bracket 210 may be configured to securely attach scaffold structural member 110 (shown in FIG. 1) to vehicle 50. In various embodiments, mounting bracket 210 may be rigidly mounted to a side of vehicle 50 via a selectively detachable connection. In various embodiments, mounting bracket 210 may be configured to securely attach scaffold structural member 110 to the vehicle 50 by any fastening configuration. For example, a bolt or rivet fastening configuration may be utilized on a side of vehicle 50 to receive mounting bracket 210. In some embodiments, the position at which the bolts/rivets may be used to attach mounting bracket 210 to vehicle 50 may be moved up or down relative to vehicle 50 to enable mounting system 200 to be attached thereto.

In various embodiments, interconnect member 220 may be affixed to mounting bracket 210, and engaging member 230 may be affixed to interconnect member 220. In some embodiments, interconnect member 220 may be rigidly affixed to mounting bracket 210. For example, interconnect member 220 may be fixedly coupled to or integrally formed with mounting bracket 210. In other embodiments, mounting bracket 210 and/or the interconnect member 220 may be affixed by any suitable fastening configuration now known or future developed. In various embodiments, engaging member 230 may be removably affixed to interconnect member. For example, interconnect member 220 may include a male component configured to be inserted into a female component of engaging member 230. In some embodiments, interconnect member 220 may include openings through which a portion of engaging member 230 may be inserted, and engaging member 230 may include an engaging portion 235 comprising a cutout that is configured to receive a portion of interconnect member 220. In some embodiments, a terminal end of interconnect member 220 may include a rounded, curved, conical, and/or tapered portion to facilitate positioning of the engaging member 230 into the interconnect member 220, as shown in FIG. 3B. In a similar manner, interconnect member 220 may include a cooperating slope or taper to further simplify the engagement therebetween. In particular embodiments, the interconnect member 220 and the engaging member 230 may each have complementary shaped configurations.

In various embodiments, a fall protection member (e.g., scaffold structural member 110) may be secured to vehicle 50 via engaging member 230. For example, in various embodiments, a first end of engaging member 230 may be affixed to interconnect member 220, and a second end opposite the engaging member 230 may include an opening configured to receive a horizontal structural unit 120 of scaffold structural member 110. As described herein with respect to FIGS. 4-6, crane fall protection system 100 may include scaffold structural member 110 and/or one or more other components that may or may not be affixed to the vehicle (e.g., via mounting system 200).

FIGS. 4-6 depict example embodiments of crane fall protection system 100, according to one or more aspects described herein. For example, crane fall protection system 100 may include a deployable arm-based crane fall protection system 300, an air bag-based crane fall protection system 400, an outrigger-mounted crane fall protection system 500, or a combination thereof. The components of the embodiments of crane fall protection system 100 depicted in FIGS. 4-6 may be variously combined to form a single crane fall protection system 100 for use on a vehicle (e.g., vehicle 50). In FIGS. 4-6, the various embodiments of crane fall protection system 100 are depicted for the purpose of illustration and description as being located on a side of vehicle 50. However, in various embodiments, the components of crane fall protection system 100 are included on one or multiple sides of vehicle 50. For example, in some embodiments, components of crane fall protection system 100 are included on all four sides (or a portion of all four sides) of a crane to ensure adequate fall protection is provided on each side.

FIG. 4 depicts a perspective view of a deployable arm-based crane fall protection system 300, according to one or more aspects described herein. In various embodiments, crane fall protection system 300 may include a fall protection member that is configured as a deployable arm. For example, the fall protection member may comprise components that are attached to one another and vehicle 50, and that may deploy off of vehicle 50 when a crane is positioned within a building or construction site. In various embodiments, crane fall protection system 300 may include a safety net 310, an accessing member 320, a scaffold structural member comprising vertical structural units 330 and horizontal structural units 340 connected via structural connectors 335, and/or one or more other components. In various embodiments, safety net 310 may be attached to one or more (predefined) connecting points 52 on a side of vehicle 50. Safety net 310 may be attached to connecting points 52 by fastening, threading, and/or other suitable attaching means. In some embodiments, safety net 310 may be attached to connecting points 52 using a hook, fastener, pin, and/or other components. In various embodiments, deployable arm-based crane fall protection system 300 may rely on connecting points 52 available on a deck of a crane to ensure optimal distribution of loads while minimizing shear and tensile stress caused by a falling object caught by safety net 310.

As described herein, safety net 310 may be configured to decrease impact force of falling objects, including operators falling from a crane. Safety net 310 may be of any appropriate shape and size that meets the requirements of OSHA and is suitable based on a Failure Modes and Effects Analysis (FMEA) and stress calculations for lateral stability. In various embodiments, safety net 310 may be of a generally rectangular shape. In other embodiments, however, safety net 310 may be of any other appropriate shape, including, without limitation, circular, non-circular, square, polygonal, triangular, oval or a combination of such. In various embodiments, safety net 310 may be of any configuration and positioned in any appropriate location around vehicle 50. In some embodiments, safety net 310 may be connected to structural units 330 of the scaffold structural member (which may be the same as or similar to scaffold structural member 110) and/or vehicle 50 at predefined maximum length intervals. For example, in some embodiments, safety net 310 may be connected to the scaffold structural member and/or vehicle 50 at a maximum of 4-foot intervals. In some embodiments, safety net 310 may also be connected to outrigger 55 of vehicle 50. In various embodiments, safety net 310 may include apertures or openings that receive falling objects therewith and may be positioned along the vehicle 50 at a desired location where it may be fastened to the vehicle 50 and to adjustable structural unit 330.

In various embodiments, accessing member 320 may be configured to provide an operator or other individual access to a rigid ladder frame of the vehicle 50. For example, as shown in FIG. 4, accessing member 320 may comprise a door flap or other type of aperture within the deployable arm of crane fall protection system 300 (e.g., within safety net 310) that is located adjacent to a rigid ladder of vehicle 50. In some embodiments, the accessing member 320 may comprise a rigid door flap or a soft door flap. In some embodiments, accessing member 320 may be integrally formed with the safety net 310. In other embodiments, accessing member 320 may be detachably formed with safety net 310. In some embodiments, accessing member 320 may be pulled with a rope attached to the accessing member 320.

In various embodiments, deployable arm-based crane fall protection system 300 may include a scaffold structural member the same as or similar to scaffold structural member 110 described herein. For example, the scaffold structural member that forms the deployable arm of crane fall protection system 300 may include vertical structural units 330 and horizontal structural units 340 the same as or similar to structural units 120. In some embodiments, vertical structural units 330 and horizontal structural units 340 may be connected via structural connectors 335 the same as or similar to structural connector 130. In other words, vertical structural units 330 and horizontal structural units 340 may be connected as described herein with respect to structural units 120. In various embodiments, the scaffold structural member of crane fall protection system 300 may be connected to vehicle 50 via a mounting system the same as or similar to mounting system 200 described herein with respect to FIG. 3A and FIG. 3B. In various embodiments, vertical structural units 330 and/or horizontal structural units 340 may be spaced apart from one another to provide structural support for safety net 310.

In some embodiments, vertical structural units 330 may be selectively adjustable to enable an operator to adjust the height of horizontal structural units 340 between vertical structural units 330. As shown in FIG. 4, structural connectors 335 may be configured to telescopingly connect vertical structural units 330 and horizontal structural units 340. In some embodiments, the telescoping connection between vertical structural units 330 and horizontal structural units 340 may enable an operator to adjust the height of horizontal structural units 340 between vertical structural units 330 without having to disconnect or detach horizontal structural units 340 from vehicle 50. In various embodiments, horizontal structural units 340 of scaffold structural member may be configured to provide structural support for safety net 310. In some embodiments, horizontal structural units 340 may be integrally formed with safety net 310.

In some embodiments, feet of scaffold structural member (e.g., located at end of vertical structural units 330 opposite structural connectors 335) may be configured to be positioned between 7 feet to 9 feet from a side of vehicle 50 when crane fall protection system 300 is in a deployed position (i.e., when the deployable arm is extended away from the vehicle). In an example embodiment, feet of scaffold structural member are configured to be positioned approximately 8 feet from a side of vehicle 50. In some embodiments, scaffold structural member may be configured to be adjusted to one or more predefined heights in order to optimize placement of the safety net 310 relative to the connecting points 52.

In various embodiments, deployable arm-based crane fall protection system 300 may include an engaging strap 350 that extends from the scaffold structural member to connecting points 52. In some embodiments, engaging strap 350 may be configured to engage an engaging device 355 of connecting points 52. The engaging strap 350 and engaging device 355 may be configured to ensure that safety net 310 may be securely attached to vehicle 50. In some embodiments, engaging device 355 may be a hook. In other embodiments, safety net 310 may be attached to connecting points 52 via any appropriate manner, such as through fastening, threading, or being detachably attached thereto. In some embodiments, engaging strap 350 may be integrally formed with safety net 310. In other embodiments, engaging strap 350 may be separate from safety net 310.

In some embodiments, horizontal structural units 340 and engaging straps 350 may extend between vehicle 50 and structural connectors 335 to connect the other components scaffold structural member to vehicle 50. In other embodiments, engaging straps 350 alone may extend between vehicle 50 and structural connectors 335 to connect the other components scaffold structural member to vehicle 50. In various embodiments, engaging straps 350 may be configured to be adjusted to accommodate various lengths between a side of vehicle 50 and vertical structural units 330. In some embodiments, engaging straps 350 may be between 8 feet to 9 feet in length. In some embodiments, engaging straps 350 may include a padded surface to allow optimized engagement with safety net 310, and to prevent damage or harm to crane fall protection system 300 and falling objects when falling objects land on crane fall protection system 300.

In various embodiments, deployable arm-based crane fall protection system 300 may include a tension wire 360 configured to provide tensile support to the scaffold structural member. In various embodiments, tension wire 360 may be configured to provide tensile support to safety net 310. In some embodiments, an outrigger pad 344 may be placed underneath outrigger feet 57 of outrigger 55. In such embodiments, tension wire 360 may be selectively attached to outrigger pad 344 to anchor tension wire 360 underneath the weight of vehicle 50.

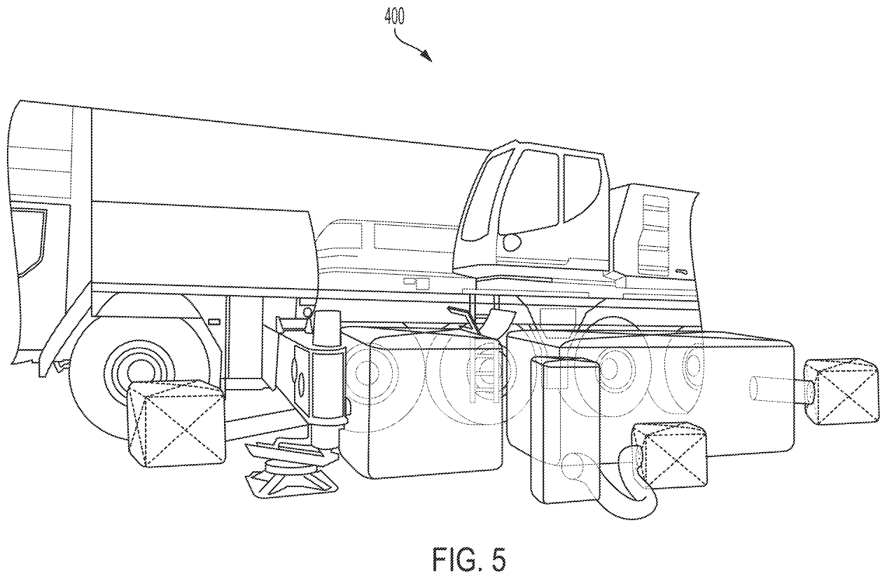

FIG. 5 depicts a perspective view of an air bag-based crane fall protection system 400, according to one or more aspects described herein. In various embodiments, crane fall protection system 400 may include one or more air inflatable units, one or more air pumps, an air duct, an accessing member, and/or one or more other components. In some embodiments, the air inflatable unit may be configured to provide access to the ladder and/or to vehicle 50. Notably, a ladder may be difficult to place adjacent to a side of the vehicle due to OSHA regulations. In some embodiments, the accessing member of crane fall protection system 400 may include a flap. In some embodiments, the accessing member may be attached to one of the air inflatable units, or between two or more of the air inflatable units. In some embodiments, a first air inflatable unit may be slid in between the one or more air inflatable units and located underneath the flap. In some embodiments, the flap may be pulled by using a rope attached to the flap. In some embodiments, the one or more air pumps may be configured to receive power from the vehicle. In other embodiments, the one or more air pumps may be configured to receive power from an external generator and/or other power source. Similar to deployable arm-based crane fall protection system 300, the air inflatable unit(s) of crane fall protection system 400 may be of any appropriate shape and size that meets the meets the requirements of OSHA and is suitable based on a FMEA and stress calculations for lateral stability. In some embodiments, the air inflatable unit(s) may be of a generally rectangular shape, but may also be of any appropriate shape, including, without limitation, circular, non-circular, square, polygonal, triangular, oval or a combination of such. In some embodiments, the air inflatable unit(s) may be of any configuration and positioned in any appropriate location around vehicle 50. In some embodiments, the air inflatable unit(s) may be positioned along vehicle 50 at desired location and fastened to vehicle 50 and/or to one or more structural units extending from vehicle 50. In other embodiments, air inflatable unit(s) may be positioned along vehicle 50 at a desired location without being fastening to vehicle 50. In some embodiments, one or more air inflatable units may be used in combination with a deployable arm system as described herein. For example, the crane fall protection system may comprise a deployable arm system as described herein with one or more air inflatable units positioned underneath the safety net.

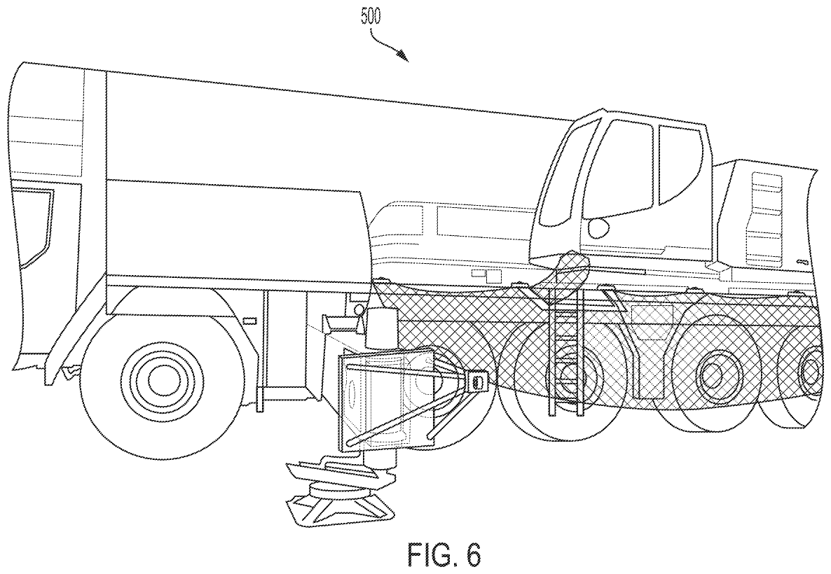

FIG. 6 depicts a perspective view of an outrigger-mounted crane fall protection system 500, according to one or more aspects described herein. In various embodiments, crane fall protection system 500 may include a safety net, an outrigger attaching unit, a horizontal cable, and/or one or more other components. In various embodiments, crane fall protection system 500 may be configured to selectively attach the safety net to mounting points or openings in the side of the vehicle and to a clamp of the outrigger. For example, the safety net may be attached to the clamp of the outrigger using a fastener, pin, or hook. In some embodiments, a wire cable of the safety net may be connected to a clamp of the outrigger located approximately 8 feet from the vehicle. In other embodiments, a wire cable of the safety net may be attached through an opening located in a mounting system. In some embodiments, outrigger-mounted crane fall protection system 500 may be designed for minimal components and a rapid setup/teardown time. In some embodiments, the safety net design of outrigger-mounted crane fall protection system 500 may be extended the entire width. Similar to deployable arm-based crane fall protection system 300, the safety net of outrigger-mounted crane fall protection system 500 may be of any appropriate shape and size that meets the meets the requirements of OSHA and is suitable based on a FMEA and stress calculations for lateral stability. In some embodiments, the safety net may be of a generally rectangular shape, but may also be of any appropriate shape, including, without limitation, circular, non-circular, square, polygonal, triangular, oval or a combination of such. In some embodiments, the safety net may be of any configuration and positioned in any appropriate location around vehicle 50. In various embodiments, the safety net may include apertures or openings that receive the falling objects therewith and may be positioned along the vehicle at a desired location where it may be fastened to the vehicle and to one or more adjustable structural units extending from vehicle 50. In some embodiments, the outrigger-mounted system may be used in combination with a deployable arm system as described herein. For example, the crane fall protection system may comprise a deployable arm system as described herein in which the safety net is also mounted to one or more outriggers, as described with respect to outrigger-mounted crane fall protection system 500.

It is to be understood that the invention is not limited in its application to the details of construction and the arrangement of the components set forth herein. The invention is capable of other embodiments and of being practiced or being carried out in various ways. Variations and modifications of the foregoing are within the scope of the present invention. It should be understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

While the preferred embodiments of the invention have been shown and described, it will be apparent to those skilled in the art that changes and modifications may be made therein without departing from the spirit of the invention, the scope of which is defined by this description.

Reference in this specification to “one implementation”, “an implementation”, “some implementations”, “various implementations”, “certain implementations”, “other implementations”, “one series of implementations”, or the like means that a particular feature, design, structure, or characteristic described in connection with the implementation is included in at least one implementation of the disclosure. The appearances of, for example, the phrase “in one implementation” or “in an implementation” in various places in the specification are not necessarily all referring to the same implementation, nor are separate or alternative implementations mutually exclusive of other implementations. Moreover, whether or not there is express reference to an “implementation” or the like, various features are described, which may be variously combined and included in some implementations, but also variously omitted in other implementations. Similarly, various features are described that may be preferences or requirements for some implementations, but not other implementations.

The language used herein has been principally selected for readability and instructional purposes, and it may not have been selected to delineate or circumscribe the inventive subject matter. Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A crane fall protection system comprising:
a safety net configured to minimize damage or harm to falling objects at or around the base of a crane; and
a scaffold structural member securely attached to a side of the crane, wherein the scaffold structural member comprises structural units that combine to form a scaffold structure at the base of the crane that is configured to support the safety net.

2. The crane fall protection system of claim 1, wherein the scaffold structural member is configured to selectively deploy from a side of the crane when the crane is positioned within a building or construction site.

3. The crane fall protection system of claim 1, wherein the safety net is attached at one or more predefined connecting points on the side of the crane.

4. The crane fall protection system of claim 1, wherein the safety net includes an aperture configured to provide access to a ladder attached to the crane.

5. The crane fall protection system of claim 4, wherein the aperture comprises a door flap integrally formed within the safety net.

6. The crane fall protection system of claim 1, further comprising a tension wire configured to provide tensile support to the safety net and/or the scaffold structural member.

7. The crane fall protection system of claim 6, further comprising one or more outriggers pads placed underneath feet of outriggers of the crane, wherein the tension wire is attached to at least one of the one or more outrigger pads to anchor the tension wire underneath the weight of the crane.

8. The crane fall protection system of claim 1, wherein the safety net is connected to the scaffold structural member or vehicle at maximum predefined intervals.

9. The crane fall protection system of claim 8, wherein the maximum predefined intervals comprise 4-foot intervals.

10. The crane fall protection system of claim 1, wherein a height of scaffold structural member is selectively adjusted by an operator of the crane.

11. The crane fall protection system of claim 10, wherein the height of scaffold structural member is selectively adjusted to one or more predefined heights.

12. The crane fall protection system of claim 10, wherein the structural units of scaffold structural member include horizontal structural units and vertical structural units, wherein the horizontal structural units and vertical structural units are telescopingly connected to enable the height of scaffold structural member to be selectively adjusted without having to disconnect or detach any structural units from the crane.

13. The crane fall protection system of claim 1, wherein the structural units of scaffold structural member include horizontal structural units and vertical structural units, wherein the horizontal structural units are integrally formed with the safety net.

14. The crane fall protection system of claim 1, further comprising one or more air inflatable units positioned underneath the safety net.

15. The crane fall protection system of claim 1, wherein the safety net is mounted to one or more outriggers of the crane.
